(19) United States
(12) Patent Application Publication
(10) Pub. No.: US 2018/0370179 A1
(43) Pub. Date: Dec. 27, 2018

(54) INTERNAL TANK TUBE AND TANK HAVING AT LEAST ONE INTERNAL TUBE

(71) Applicant: TI AUTOMOTIVE (FULDABRÜCK) GMBH, Fuldabrück (DE)

(72) Inventor: Werner ZIMMER, Melsungen/Röhrenfurth (DE)

(21) Appl. No.: 15/776,090

(22) PCT Filed: Nov. 8, 2016
(86) PCT No.: PCT/EP2016/076910

§ 371 Date: May 15, 2018

(30) Foreign Application Priority Data
Nov. 23, 2015 (EP) 15195886.5

(51) Int. Cl. B32B 1/08; B60K 15/01; B32B 7/12; B32B 3/28; B32B 27/08; B32B 27/18; B32B 27/34

(52) U.S. Cl. CPC B32B 1/08; B60K 15/01; B32B 7/12; B32B 3/28; B32B 27/08; B32B 27/18; B32B 2439/40; B32B 2250/03; B32B 2250/24; B32B 2307/202; B32B 2307/732; B32B 2597/00; B32B 2605/00; B32B 27/34

(57) ABSTRACT

Disclosed is an internal tube in tanks, in particular in motor vehicle fuel tanks, comprising a fluid duct that is surrounded by a tube wall. The tube wall is composed of at least three layers, an outer layer being based on an aromatic polyamide. A polyamide-based intermediate layer as well as an aromatic polyamide-based inner layer are provided. The tube has a total wall thickness of 0.5 to 3.5 mm.

### RELATED APPLICATIONS

This application is a 35 U.S.C. § 371 national phase application of International Application No. PCT/EP2016/076910, filed on Nov. 8, 2016, which claims the priority of European Patent Application EP 1519588.5, filed Nov. 23, 2015, the contents of which are incorporated herein by reference in their entirety.

### FIELD

The present disclosure refers to an internal tank tube, in particular in fuel tanks of motor vehicles, wherein the tube has a fluid duct that is surrounded by a tube wall. The present disclosure also refers to a tank having at least one such internal tank tube.

### BACKGROUND

The internal tank tubes are fundamentally known in practice in various embodiments. This is also true for internal tank tubes in fuel tanks of motor vehicles. These tubes are currently adapted for resisting only to temperatures below 70° C., i.e. they can reliably operate below these temperatures. Moreover, many of these known tubes have the drawback that the flowing fuel may wash out components from the material of the tube wall. Thereby, in the long run, the functionality of the fuel supply system is negatively impacted. Moreover, the constructions of many of these known tubes are relatively expensive and/or require relatively high quantities of plastic material for the tube walls. Insofar the known internal tank tubes may be improved.

### SUMMARY

The present disclosure provides an internal tank tube characterized by a high thermal resistance, in particular up to temperature of at least 120° C., the wall material of which is resistant to undesired washouts and which has a simple construction and is easy to manufacture. Another object of the present disclosure is to provide a tank having at least one such internal tank tube.

In order to achieve these objects, the present disclosure discloses an internal tank tube—in particular within fuel tanks of motor vehicles—wherein the tube has a fluid duct surrounded by a tube wall, wherein the tube wall is composed of at least three layers, wherein one outer layer is based on an aromatic polyamide, wherein an intermediate layer is based on polyamide—preferably an aliphatic polyamide—wherein an inner layer is based on an aromatic polyamide and wherein the total wall thickness of the tube is between 0.5 mm and 3.5 mm, preferably between 0.6 and 3 mm and most preferably between 0.6 and 2.5 mm. According to one form of the present disclosure, an outer layer is based on polyphtalamide (PPA) and/or an inner layer is based on polyphtalamide (PPA). It is recommended that the intermediate layer between the outer and the inner layer is based on an aliphatic polyamide.

It lies within the scope of the present disclosure that the outer layer is composed of at least 80 wt.-%, preferably 85 wt.-%, preferably at least 90 wt.-% and most preferably of 95 wt.-% of an aromatic polyamide and that it is recommended that it is composed of polyphtalamide. According to one form, the outer layer is composed of at least 97 wt.-%, preferably at least 98 wt.-% of the aromatic polyamide, and it is recommended that it is composed of polyphtalamide (PPA). In one construction the outer layer has a thickness of 0.1 mm to 1.3 mm, preferably from 0.2 to 1.2 mm, preferably from 0.2 mm to 1 mm and most preferably from 0.25 mm to 0.9 mm. The present disclosure also comprises the fact that the outer layer is electrically conductive. To this end, the outer layer is advantageously provided with suitable conductive additives—such as carbon black or similar.

The intermediate layer consists of at least 80% by weight, preferably at least 85% by weight, preferably at least 90% by weight and very preferably at least 95% by weight of a polyamide and preferably an aliphatic polyamide. According to one form of the present disclosure, the intermediate layer consists of at least 97% by weight and preferably at least 98% by weight of the polyamide, and it is recommended to be made of aliphatic polyamide. The intermediate layer may be formed on the basis of polyamide 6. According to another embodiment, the intermediate layer is based on polyamide 12 and/or polyamide 6.6. The intermediate layer 20 may have a layer thickness of 0.1 to 1.3 mm, preferably of 0.2 to 1.2 mm, preferably of 0.2 mm to 1 mm and very preferably of 0.25 mm to 0.9 mm. Fundamentally, also the intermediate layer can be electrically conductive.

It is within the scope of the present disclosure that the inner layer of the tube comprises at least 80% by weight, preferably at least 85% by weight, preferably at least 90% by weight and very preferably at least 95% by weight of an aromatic polyamide and preferably of polyphthalamide (PPA). The inner layer may be made of at least 97% by weight and preferably at least 98% by weight of the aromatic polyamide and in particular of polyphthalamide (PPA). The inner layer of the tube may have a layer thickness of 0.1 mm to 1.3 mm, preferably of 0.2 mm to 1.2 mm, preferably from 0.2 mm to 1 mm and more preferably from 0.25 mm to 0.9 mm—it has proved advantageous to provide the outer layer as electrically conductive. For this purpose, the outer layer is advantageously provided with suitable conductivity additives—for example with carbon black or the like.

In one form of the present disclosure the intermediate layer has a higher layer thickness than the outer layer and/or the inner layer. Conveniently, the intermediate layer is the thickest layer of the tube wall of the inventive internal tank tube. Preferably, the intermediate layer is 1.1 to 2.5 times and preferably 1.2 to 2 times and very preferably 1.2 to 1.8 times as thick as the outer layer and/or the inner layer—according to a tested embodiment of the present disclosure, both the outer layer and the inner layer are electrically conductive. Basically, the intermediate layer may also be electrically conductive.

In one form of the present disclosure the inventive internal tank tube has only three layers comprising the outer layer, intermediate layer and inner layer. In principle, however, the internal tank tube according to the present disclosure can also have further layers. Thus, the outer layer can be connected to the intermediate layer via an adhesive layer, which adhesive layer improves the adhesion between outer layer and intermediate layer. Alternatively, or additionally, the intermediate layer with the inner layer may be connected via an adhesive layer, which adhesive layer improves the adhesion between the inner layer and the intermediate layer. It is also within the scope of the present disclosure that between the outer layer and the inner layer at least one barrier layer is arranged, which has barrier properties with respect to the fuel flowing through the tube or with respect to a component of this fuel.

According to an embodiment, the internal tank tube is connected to a pump arranged in the associated tank—in particular in the associated fuel tank of the motor vehicle. By means of the pump, the fluid medium in the tank or the fuel in the fuel tank is supplied through the internal tank tube. The internal tank tube according to the present disclosure can also allow the equalization of the pressure and/or the level compensation between different areas of the tank or fuel tank. In any case, the internal tank tube according to the present disclosure is arranged in the interior or in the internal space of a tank or fuel tank.

One embodiment of the present disclosure is characterized in that the internal tank tube is designed at least in portions—preferably completely—in the form of a corrugated tube. It is within the scope of the present disclosure that the wave crests and troughs of the tube run around the circumference of the tube. Expediently, the wave crests and the wave troughs of the tube have equal/constant distances from one another or substantially equal/constant distances from one another over at least a portion of the length of the tube, preferably over the entire length or essentially over the entire length of the tube. This design has particular advantages in view of the mechanical and thermal properties of the tube.

The present disclosure also provides a tank—in particular a fuel tank for motor vehicles—which has at least one internal tank tube according to the present disclosure in its inner space. According to one embodiment, the internal tank tube is at least partially disposed on the wall of the tank or fuel tank. In principle, however, the internal tank tube can also run through other regions of the tank or fuel tank.

The present disclosure is based on the finding that the internal tank tube according to the present disclosure is characterized by an excellent temperature resistance and also by an optimal mechanical resistance. The tubes according to the present disclosure are resistant to temperatures of −40° C. to 120° C. and more and can thus be used for a variety of applications in tanks, especially in fuel tanks of motor vehicles. The present disclosure is also based on the discovery that the need for temperature-resistant piping for the interior of tanks or fuel tanks is increasing. The tank internal tubes according to the present disclosure also prove to be very advantageous in the production of a tank according to the ship-in-bottle principle. In this process, a hose made from the tank wall material is equipped with all the necessary units—such as the pump, level sensor and the like—and then inflated to the desired shape. For this purpose, the tube is subject to relatively high heating. The inventive internal tank tubes—which are also arranged in the tube—withstand this treatment without problems. Furthermore, it is of particular advantage in the internal tank tube according to the present disclosure, that it can be used without problems and without restrictions also for different types of fuel, such as gasoline or diesel—the tube according to the present disclosure is further characterized by an optimal chemical resistance. Washouts of plastic components by the fuel supplied through the tube do not take place or occur only to a negligible extent. The internal tank tube according to the present disclosure also fulfils all mechanical requirements. Furthermore, it can be produced in a simple and inexpensive manner and, in particular, in a material-saving manner.

### BRIEF DESCRIPTION OF THE DRAWINGS

The present disclosure will be explained in more detail below with reference to a drawing which represents only one depicted embodiment.

In a schematic representation:

FIG. 1 shows a section through a fuel tank of a motor vehicle with an internal tank tube according to the present disclosure and

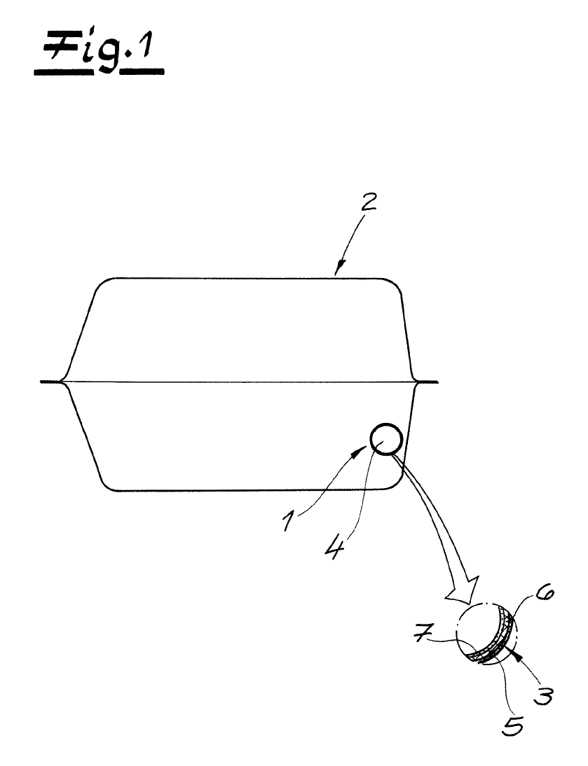

FIG. 2 shows a perspective view of the internal tank tube 20 according to the present disclosure.

### DETAILED DESCRIPTION

Now, a preferred embodiment of the present disclosure will be described in conjunction with the accompanying drawings. The sizes, materials, and other specific numerical values in the following description of the embodiment are simply by way of examples for ease of understanding of the present disclosure and should not be construed to limit the present disclosure unless otherwise specified. Note that in the description and the drawings, components having substantially the same functions and configurations are designated by the same reference characters, so that their description is not repeated, while components not directly relevant to the present disclosure are not shown.

The term “internal tank tube” in the context of the present disclosure means that the inventive tube is positioned within the internal space of a tank or that it extends through the internal space of the tank. The tube is in particular an internal tank tube, which extends through the internal space of a fuel tank of a motor vehicle. Inasmuch, the present disclosure refers in particular to a motor vehicle tank internal tube.

The figures show an internal tank tube 1 according to the present disclosure which in the depicted embodiment is preferably located in a fuel tank 2 of a motor vehicle. In a fuel tank 2 provided with the tube 1 according to the present disclosure, fundamentally different types of fuels, for example diesel fuel or gasoline, can be contained. The tube 1 according to the present disclosure has, as usual, a fluid duct 4 surrounded by a tube wall 3.

According to a preferred embodiment and in the depicted embodiment the tube wall 3 has three layers 5, 6, 7. The outer layer 5 in the embodiment is preferably made of polyphthalamide (PPA) or substantially made of polyphthalamide (PPA). Besides polyphthalamide (PPA), the outer layer 5 may be provided with additives such as conductivity additives or stabilizing additives or the like. In the depicted embodiment, an intermediate layer 6 is connected directly to the outer layer 5, which intermediate layers in the depicted embodiment preferably consists of an aliphatic polyamide or substantially of an aliphatic polyamide, preferably, in the depicted embodiment, polyamide 6. In addition, the intermediate layer 6 can contain additives, such as conductivity additives, stabilizing additives and the like. Preferably, in the depicted embodiment, the inner layer 7 is connected directly to the intermediate layer 6. This preferred embodiment of the inner layer 7 is made of polyphthalamide (PPA) or is substantially composed of polyphthalamide (PPA). Furthermore, this inner layer 7 may also contain additives such as conductivity additives, stabilizing additives and the like.

Preferably, in the depicted embodiment, the total wall thickness of the tube wall 3 is between 0.8 and 2.0 mm. The recommended layer thicknesses of the three layers 5, 6, 7 in the embodiment are respectively corresponding to 15 to 45% of the total wall thickness. Preferably, and in the depicted embodiment, the intermediate layer 6 is thicker than the outer layer 5 and also thicker than the inner layer 7. This embodiment has proven to be particularly useful in the context of the present disclosure.

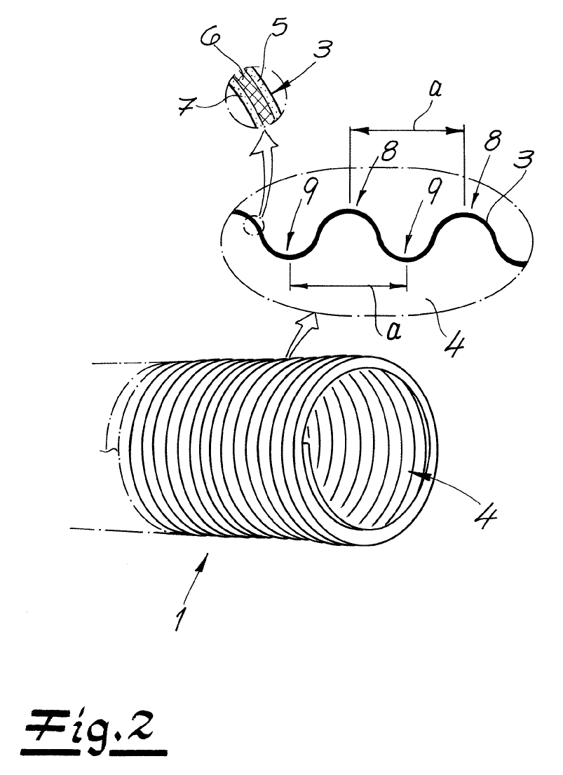

Preferably, in the embodiment, all three layers 5, 6, 7 are electrically conductive. For this purpose, the layers 5, 6, 7 are provided with suitable conductivity additives, such as carbon black or the like—according to a particularly preferred embodiment and in the example, the internal tank tube 1 according to the present disclosure is designed as a corrugated tube. This is particularly evident in FIG. 2. In this corrugated-shaped internal tank tube 1, the wave crests 8 and the wave troughs 9 preferably extend, in the depicted embodiment, over the entire circumference of the tube 1. Incidentally, the recommended wave crests 8 and wave troughs 9 in the depicted embodiment have the same or constant distances over the length of the tube 1.

1. A fuel tank for motor vehicles, comprising at least one tank internal tube arranged in the interior of the tank, wherein the tank internal tube has a fluid channel surrounded by a tube wall, wherein the tube wall consists of at least three layers, wherein an outer layer is based on an aromatic polyamide, wherein an intermediate layer is based on polyamide, wherein an inner layer is based on an aromatic polyamide, and wherein the total wall thickness of the tank internal tube is between 0.5 mm to 3.5 mm.

2. The tank according to claim 1, wherein the outer layer of the tank internal tube consists of at least 80% by weight of an aromatic polyamide, in particular polyphthalamide.

3. The tank according to claim 1, wherein the outer layer of the tank internal tube has a layer thickness of 0.1 mm to 1.3 mm, preferably of 0.2 mm to 1.2 mm, and especially preferably of 0.2 mm to 1 mm.

4. The tank according to claim 1, wherein the intermediate layer of the tank internal tube consists of at least 80% by weight, preferably at least 85% by weight, and especially preferably at least 90% by weight polyamide and/or aliphatic polyamide.

5. (canceled)

6. The tank according to claim 1, wherein the intermediate layer of the tank internal tube has a layer thickness of 0.1 mm to 1.3 mm.

7. The tank according to claim 1, wherein the inner layer of the tank internal tube consists of at least 80% by weight of an aromatic polyamide.

8. The tank according to claim 1, wherein the inner layer of the tank internal tube has a layer thickness of 0.1 mm to 1.3 mm.

9. The tank according to claim 1, wherein any one or more of the inner layer and the intermediate layer and the outer layer of the tank internal tube are designed to be electrically conductive.

10. The tank according to claim 1, wherein the tank internal tube has only the three layers, comprising the outer layer, the intermediate layer and the inner layer.

11. The tank according to claim 1, wherein the intermediate layer is thicker than the outer layer and the inner layer of the tank internal tube.

12. The tank according to claim 1, wherein the intermediate layer bonded to at least one of the inner layer and the outer layer by at least one adhesive layer.

13. The tank according to claim 1, wherein the tank internal tube is connected to a pump arranged in the fuel tank of the motor vehicle.

14. The tank according to claim 1, wherein the tank internal tube is designed in the form of a corrugated tube in at least some regions.

15. The tank according to claim 1, wherein the outer layer is based on polyphthalamide.

16. The tank according to claim 1, wherein the intermediate layer is based on an aliphatic polyamide.

17. The tank according to claim 1, wherein the inner layer is based on polyphthalamide.

18. The tank according to claim 1, wherein the total wall thickness of the tank internal tube is between 0.6 mm to 3 mm.

19. The tank according to claim 1, wherein the total wall thickness of the tank internal tube is between 0.6 mm to 2.5 mm.

20. The tank according to claim 15, wherein the outer layer of the tank internal tube consists of at least 90% by weight of polyphthalamide.

21. The tank according to claim 1, wherein the outer layer of the tank internal tube has a layer thickness of 0.2 mm to 1 mm.

22. The tank according to claim 16, wherein the intermediate layer of the tank internal tube consists of at least 90% by weight of ate least one of polyamide and aliphatic polyamide.

23. The tank according to claim 1, wherein the intermediate layer of the tank internal tube has a layer thickness of 0.2 mm to 1 mm.

24. The tank according to claim 17, wherein the inner layer of the tank internal tube consists of at least 90% by weight of polyphthalamide.

25. The tank according to claim 1, wherein the inner layer of the tank internal tube has a layer thickness of 0.2 mm to 1 mm.
